(19) United States
(12) Patent Application Publication
(10) Pub. No.: US 2026/0202270 A1
(43) Pub. Date: Jul. 16, 2026

(54) DEVICE FOR DETECTING THE COMPRESSIVE FORCES BETWEEN TWO BODIES THAT CAN BE PLACED AGAINST EACH OTHER UNDER THE ACTION OF FORCE

(71) Applicant: NET-Automation GmbH, Peter ob Judenburg (AT)

(72) Inventors: Christian Zuber, St. Peder ob Judenburg (AT); Gernot Theuermann, St. Peder ob Judenburg (AT); Walter Rieger, St. Peder ob Judenburg (AT)

(21) Appl. No.: 19/134,641

(22) PCT Filed: Nov. 14, 2023
(86) PCT No.: PCT/AT2023/060391

§ 371 Date: May 30, 2025

(30) Foreign Application Priority Data
Nov. 30, 2022 (AT) A 50912/2022

(51) Int. Cl. G01L 1/18; G01L 5/28

(52) U.S. Cl. CPC G01L 1/18; G01L 5/28

(57) ABSTRACT

A device for detecting the compressive forces between two bodies (1, 2) that can be placed against each other under the action of force comprises a measuring foil (8) that can be inserted into the butt joint (6) between the two bodies (1, 2), is arranged between two cover layers (9), and has electrical properties that change depending on the compression. The two tensile-resistant cover layers (9) are connected to each other in a shear-resistant manner.

### TECHNICAL AREA

The invention relates to a device for detecting the compressive forces between two bodies that can be placed against each other under the action of force, with a measuring foil which can be inserted into the butt joint between the two bodies, is arranged between two cover layers and has electrical properties that change depending on the compression.

### STATE OF THE ART

To detect the clamping forces of disc or drum brakes, it is known (AT 524 872 B1) to insert a multi-layer measuring foil consisting of a sensor layer with electrical properties that change depending on compression, usually arranged between two cover layers, between the brake body and the brake rotor. With the help of two electrically conductive layers, the pressure-dependent changing electrical measurement signal of the sensor layer is tapped and fed to an evaluation device in which the clamping forces occurring are determined based on the known compression dependence of the electrical measurement signal. These known measuring devices reliably detect the clamping forces provided that the measuring foil is only subjected to compressive forces. If this is not the case with block brakes, for example, whose brake blocks interact with a conical wheel surface, the force component acting parallel to the measuring foil causes shear forces that adversely affect the measurement result, even if the measuring foil is arranged between two protective cover layers. This applies not only to the detection of the clamping forces of block brakes, but generally to the detection of compressive forces between two bodies that can be positioned against each other under the effect of force with a butt joint that is not perpendicular to the direction of application, in which the measuring foil is inserted for compressive force measurement.

To determine the contact force between a vehicle tire and a road surface while driving, it is known (DE 37 41 700 A1) to provide the tire with a pressure-sensitive foil along its tread in order to transfer the measurement signals obtained using the pressure-sensitive foil from the rotating wheel to a vehicle's own electronic evaluation unit via a rotary transmitter preferably designed as a magnetic coupling. To protect the foil from abrasion and moisture, the preferably piezoelectric foil can be wrapped in a protective sheath or embedded in the tread of the tire. However, wrapping a piezo foil in this way does not prevent the piezo foil from being subjected to shear forces.

### REPRESENTATION OF THE INVENTION

The invention is thus based on the problem of designing a device for detecting the compressive forces between two bodies that can be placed against each other under the action of force in such a way that the measuring results obtained by a measuring foil inserted into the butt joint between the two bodies are not influenced by any shear forces that occur.

Based on a device of the type described at the beginning, the invention solves the problem in that the two tensile-resistant cover layers are connected to each other in a shear-resistant manner.

As a result of this measure, any shear forces are absorbed by the cover layers without being transferred to the measuring foil, so that the measuring foil is only subjected to compressive stress and therefore provides reliable measurement data. The cover layers must be tensile-resistant so that the shear forces acting on the cover layers cannot cause deformation of the cover layers in their surface and thus shear loads on the measuring foil. Under these conditions, the compressive forces between two bodies that can be placed against each other under force can be reliably recorded using measuring foils with electrical properties that change depending on the compression, even with butt joints that are inclined to the direction of application, i.e. not at right angles.

Since the only important thing is a mutual shear-resistant connection between the two cover layers, the type of this shear-resistant connection plays a subordinate role and can be ensured by various measures known for this purpose, for example by riveting, welding, soldering, gluing, folding or other form-fit connections. Under certain conditions, it is sufficient to join the two cover layers together in a shear-resistant manner at least along one edge of the measuring foil.

In this context, it is advantageous to form the two cover layers from a metal foil bent by 180° along one edge of the measuring foil. In this case, particularly favorable design conditions are achieved with regard to the enclosure of the measuring foil formed by the two cover layers if the sections of the metal foil forming the cover layers are additionally connected to each other in a shear-resistant manner in the area of their edges opposite the bend, for example by riveting, folding, gluing, soldering or welding.

### BRIEF DESCRIPTION OF THE INVENTION

The drawing shows an example of the subject matter of the invention. It shows

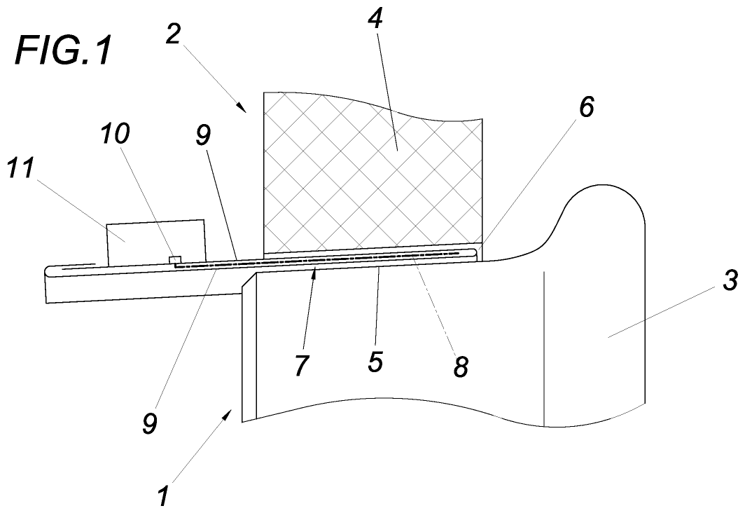

FIG. 1 a device according to the invention for detecting the compressive forces between two bodies which can be placed against each other under the action of force in a schematic section and

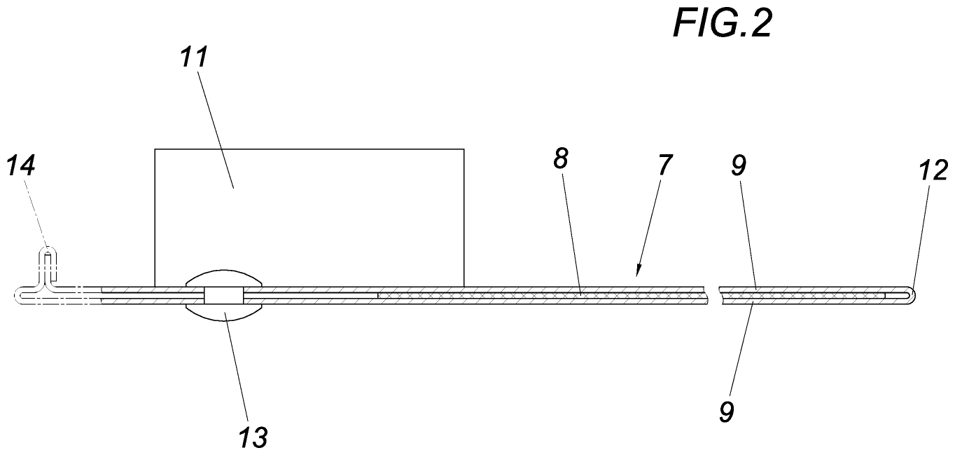

FIG. 2 a cross-section of this device on a larger scale.

### WAYS TO CARRY OUT THE INVENTION

In FIG. 1, the two bodies 1, 2, which can be set against each other under the action of force, are formed by a flanged wheel 3 and a brake block 4 of a block brake not shown in detail. In order to be able to determine the application forces of the block brake between the brake block 4 interacting with the conical running surface 5 and the flanged wheel 3, a measuring device 7 is inserted into the brake gap forming a butt joint 6 between the two bodies 1, 2, which comprises a multi-layer measuring foil 8 between two cover layers 9 and is connected to an evaluation device 11 by a plug-in coupling 10. The evaluation device 11 is preferably used not only to evaluate and/or transmit the measurement signals from the measuring foil 8, but also to apply electrical energy to the measuring foil 8.

In a manner known per se, the multi-layer measuring foil 8 has a sensor layer made of a material whose electrical properties change with the application pressure, as is particularly the case for piezoresistive materials. The sensor layer is arranged between two electrically conductive layers via which an electrical measuring voltage can be applied to the piezoresistive sensor layer. As the specific electrical resistance of the sensor layer changes with the application pressure, the magnitude of the electrical current flowing through the sensor layer can be used to infer the pressure load on the sensor layer and thus the magnitude of the acting forces due to the given compression dependence of the specific electrical resistance.

However, a prerequisite for a corresponding measurement result is that the measuring foil 8 is not subjected to any shear forces. In order to absorb any shear forces acting on the cover layers 9, the two tensile-resistant cover layers 9 are connected to each other in a shear-resistant manner so that no shear forces can be transmitted to the measuring foil via the cover layers 9. The shear-resistant connection of the two cover layers 9 can be designed in different ways.

A simple solution for such a shear-resistant connection is shown in FIG. 2. The two cover layers 9 are formed by a common metal foil which has a bend 12 by 180° along one edge of the measuring foil 8, whereby the two sections of the metal foil forming the cover layers 9 are connected to each other in a shear-resistant manner in the area of this bend 12. If, due to special design conditions or external circumstances, this shear-resistant connection along one edge of the measuring foil is not sufficient to hold the two cover layers 9 against each other in a displacement-resistant manner, additional shear-resistant connections can be provided. According to FIG. 2, rivets 13 distributed over the edge length could be provided for this purpose in the area of the edges of the cover layers 9 opposite the bend 12.

Instead of riveting, the two cover layers 9 could also be joined in another shear-resistant manner, as indicated by a dotted line in an exemplary edge fold 14.

1. A device for detecting compressive forces between two bodies that can be placed against each other with a force, said device comprising:
a measuring foil configured to be inserted into a butt joint between the two bodies, wherein said measuring foil is arranged between two tensile-resistant cover layers and has electrical properties that change depending on magnitude of force of compression thereof;
wherein the two tensile-resistant cover layers are connected to each other so as to resist shear therebetween.

2. The device according to claim 1, wherein the measuring foil has edges, and the two cover layers are connected to each other so as to resist shear therebetween at least along one edge of the measuring foil.

3. The device according to claim 2, wherein the two cover layers are formed from a metal foil bent by 180° in a bend along one of the edges of the measuring foil.

4. The device according to claim 3, wherein the metal foil forming the cover layers comprise sections that are connected to each other so as to resist shear therebetween in a region of edges thereof opposite the bend.
